(19) United States
(12) Patent Application Publication
(10) Pub. No.: US 2023/0398543 A1
(43) Pub. Date: Dec. 14, 2023

(54) WELL TRAY ANALYZERS UTILIZING REMOVEABLE MAGNETS

(71) Applicants: Aaron P. STELLA, Framingham, MA (US); DH Technologies Development Pte. Ltd., Singapore (SG)

(72) Inventor: Aaron P. STELLA, Derry, NH (US)

(73) Assignee: DH Technologies Development Pte. Ltd., Singapore (SG)

(21) Appl. No.: 18/035,210

(22) PCT Filed: Sep. 30, 2021
(86) PCT No.: PCT/US2021/052963

§ 371 Date: May 3, 2023

Related U.S. Application Data
(60) Provisional application No. 63/111,986, filed on Nov. 10, 2020.

(51) Int. Cl. B01L 3/00; B03C 1/28

(52) U.S. Cl. CPC B01L 3/5085; B03C 1/288; B01L 2200/025; B01L 2300/0829; B01L 2300/12; B03C 2201/18; B03C 2201/26

(57) ABSTRACT

A well tray includes a base including an upper surface, a lower surface and at least one edge surface connecting the upper surface to the lower surface. The at least one edge surface defines a slot. The slot is in communication with a magnet receiver at least partially defined between the upper surface and the lower surface. The magnet receiver is configured to slidably receive a removable magnet. The tray includes a plurality of wells disposed on an upper surface of the base.

This application is being filed on Sep. 30, 2021, as a PCT International Patent application and claims the benefit of and priority to U.S. Provisional patent application Ser. No. 63/111,986, filed on Nov. 10, 2020, the entire disclosure of which is incorporated by reference in its entirety.

### BACKGROUND

A well tray (also referred to as a microplate, microtiter plate, microwell plate, multiwell, etc.) is a flat plate with multiple “wells” used as small test tubes. The well tray has become a standard tool in analytical research and clinical diagnostic testing laboratories. One use is in the enzyme-linked immunosorbent assay (ELISA), the basis of most modern medical diagnostic testing in humans and animals. A well tray typically has 6, 12, 24, 48, 96, 384 or 1536 sample wells arranged in a 2:3 rectangular matrix. Each well of a well tray typically holds somewhere between tens of nanolitres to several millilitres of liquid. They can also be used to store dry powder or as racks to support glass tube inserts. Wells can be either circular or square, with flat or sloped bottoms. For compound storage applications, square wells with close fitting silicone cap-mats are preferred. Well trays can be stored at low temperatures for long periods, may be heated to increase the rate of solvent evaporation from their wells and can even be heat-sealed with foil or clear film. Magnetic particles (e.g., coated with reagents or compounds) may be utilized in certain reactions performed in well plates.

### SUMMARY

The technologies described herein incorporate one or more removable magnets into a well tray, or a well tray support platform of an analyzer, such as an imaging cytometer. By using removable magnets, a lab need only have in storage one type of well plate (e.g., a non-magnetic well tray) and may utilize a removable magnet therein only when required for a particular application. Further, well trays or support platforms that utilize removable magnets may be customized for each processing procedure, in that magnets generating stronger or weaker magnetic fields may be utilized as required or desired for a particular fluid sample, procedure, etc. By using a plurality of magnets, select rows, columns, or individual wells may be subjected to magnetic fields, thus enabling different sample processing procedures to be performed simultaneously with a single well tray (or support platform).

In one aspect, the technology relates to a well tray including: a base including: an upper surface; a lower surface, and at least one edge surface connecting the upper surface to the lower surface, wherein the at least one edge surface defines a slot, and wherein the slot is in communication with a magnet receiver at least partially defined between the upper surface and the lower surface, wherein the magnet receiver is configured to slidably receive a removable magnet; and a plurality of wells disposed on an upper surface of the base. In an example, the plurality of wells are arranged in a plurality of columns including a column width dimension and a plurality of rows including a row length dimension, and wherein the magnet receiver includes a receiver width dimension substantially similar to the column width dimension and a receiver length dimension substantially similar to the row length dimension. In another example, the plurality of wells are arranged in a plurality of columns including a column width dimension and a plurality of rows including a row length dimension, and wherein the magnet receiver includes a receiver width dimension greater than the column width dimension and a receiver length dimension greater than the row length dimension. In yet another example, the base includes a base width dimension greater than the column width dimension and a base length dimension greater than the row length dimension. In still another example, the magnet receiver includes a plurality of magnet receivers, wherein the plurality of magnet receivers are oriented substantially parallel with at least one of a row of the plurality of wells and at least one column of the plurality of wells.

In another example of the above aspect, the magnet receiver defines a reception axis along which the magnet is slidably received in the magnet receiver, and wherein the magnet receiver includes an edge support for slidably supporting an edge of the magnet. In an example, the edge support includes a height less than a height of the magnet receiver. In another example, the edge support includes a low-friction material. In yet another example, the slot includes a magnet throat for receiving the edge of the magnet during an insertion of the magnet. In still another example, the magnet throat is tapered. In another example, the lower surface at least partially defines an access opening in communication with the magnet receiver.

In another aspect, the technology relates to a sample analyzer including: a support platform for receiving a well tray, wherein the support platform includes: an upper surface; a registration feature connected to the upper surface, wherein the registration feature is configured for receiving, in a predetermined orientation, the well tray; at least one edge surface connected to the upper surface, wherein the at least one edge surface at least partially defines a slot for slidably receiving a removable magnet; and a magnet receiver defined by the support platform and in communication with the slot. In an example, the magnet receiver is configured to slidably receive the removable magnet. In another example, the registration feature is disposed so as to align the registration feature with the magnet receiver. In yet another example, the sample analyzer further includes the removable magnet, wherein the removable magnet includes a tab, wherein the tab is configured to project from the at least one edge surface when the removable magnet is disposed in the magnet receiver. In still another example, the support platform at least partially defines an access opening in communication with the magnet receiver.

In another example of the above aspect, the registration feature includes the removable magnet. In an example, the registration feature includes a plurality of projections extending from the upper surface, wherein the plurality of projections define a registration area therebetween. In another example, the magnet receiver includes a receiver area. In yet another example, the receiver area is greater than the registration area.

### BRIEF DESCRIPTION OF THE DRAWINGS

FIG. 1 is a perspective view of an example well tray configured to receive a removable magnet.

FIG. 2 depicts top and partial enlarged top views of another example of a well tray configured to receive a removable magnet.

FIG. 3 is a section view of another example of a well tray configured to receive a removable magnet.

FIG. 4 is a section view of another example of a well tray configured to receive a plurality of removable magnets.

FIG. 5 is a section view of another example of a well tray configured to receive a plurality of removable magnets.

FIG. 6 is a schematic view of a platform for a sample analyzer, the platform configured to receive a removable magnet.

### DETAILED DESCRIPTION

Uses of well trays are well known in the art. In examples, magnetic particles coated with reagents that react with target analytes in a fluid are disposed in the individual wells of the well trays. After insertion of the magnetic particles, a sample to be tested is inserted into each of the individual wells, e.g., via pipette or other instrument. Over time, the target analytes bind to the reagents on the magnetic particles, after which the sample is removed from of the wells, e.g., for further processing. In other examples, compounds coating the magnetic particles react with other substances present in the fluid disposed in the wells. After a reaction between the compounds and the substances the resulting liquid may be removed from of the wells, e.g., for further processing or other testing. Regardless of the type of test performed, it is often advantageous to fix the location of the magnetic particles in the wells so as to prevent those particles from being drawn out during pipetting procedures. As such, well trays have been manufactured that include a magnet embedded therein, e.g., below the wells. Such a construction requires that a reaction that requires magnetic particles is performed in a non-magnetic well tray, then the entire contents of each well (magnets and fluid sample) are transferred to a magnetic well tray, where the magnetic particles are bound towards the magnet, prior to further processing or analysis. This transfer necessitates an addition step that increases processing times and possibilities for errors.

As such, analyzers such as image cytometers have been developed that include a magnet disposed in a well tray support platform. After a reaction including the use of magnetic particles takes place in a non-magnetic well tray, the well tray may be placed on the well support platform, where the magnetic force generated by the magnet disposed therein acts upon the magnetic particles. Further analysis may then be performed on the sample. Well trays and support platforms that include integral magnets, while useful, can be somewhat limited and susceptible to problems. For example, the costs of both well trays and support platforms are increased if integral magnets are included. A lab may require both non-magnetic and magnetic well trays, which increases the number and types of well trays that must be kept in stock. Further, if a magnetic well tray is inadvertently inserted into an analyzer that includes a magnetic support platform, the magnetic field generated by each magnet may cause interference or may unduly increase the strength of the resulting magnetic field. Further, integrated magnets are limited in the magnetic force generated as only the force available from the magnet used, that is, the strength of the magnetic field may not be changed with an imbedded magnet. Further, the magnets integrated into the well trays or support platforms are sized to generate a magnetic field across all the wells in a well tray. This may not be desirable for certain fluid sampling processes, where it may be desirable for only discrete rows, columns, or wells to be subject to a magnetic force.

Thus, the technologies described herein include well trays and support platforms that include one or more removable magnets. By utilizing removable magnets, the same type of well trays (or support platforms) may be used for processing samples that require magnetic particles and those that do not. This enables a lab to reduce consumable costs by disposing only of the non-magnetic well trays, without disposing of the magnets, which may be reused. Further, by incorporating removable magnets, magnets having different magnetic forces may be used in different applications. Magnets may be color coded so as to enable quick reference by lab technicians for appropriate procedures. A simplified color-coding system contemplates using red, yellow, and green magnets for strong, medium, and weak magnets (as a measure of magnetic field), but other color schemes are contemplated. Further, well trays and support platforms may be manufactured from clear or translucent materials, allowing a lab technician to identify the magnet being used during a particular process. Removability also allows magnets to be inserted into a well tray or support platform only under certain rows, columns, or individual wells. This may be particularly useful for complex sample processing where not every well includes magnetic particles, or where processing requiring magnets of different strengths are utilized in a single well tray or support platform. Other advantages of incorporating removable magnets into well trays or support platforms will be apparent to a person of skill in the art upon reading the full disclosure below.

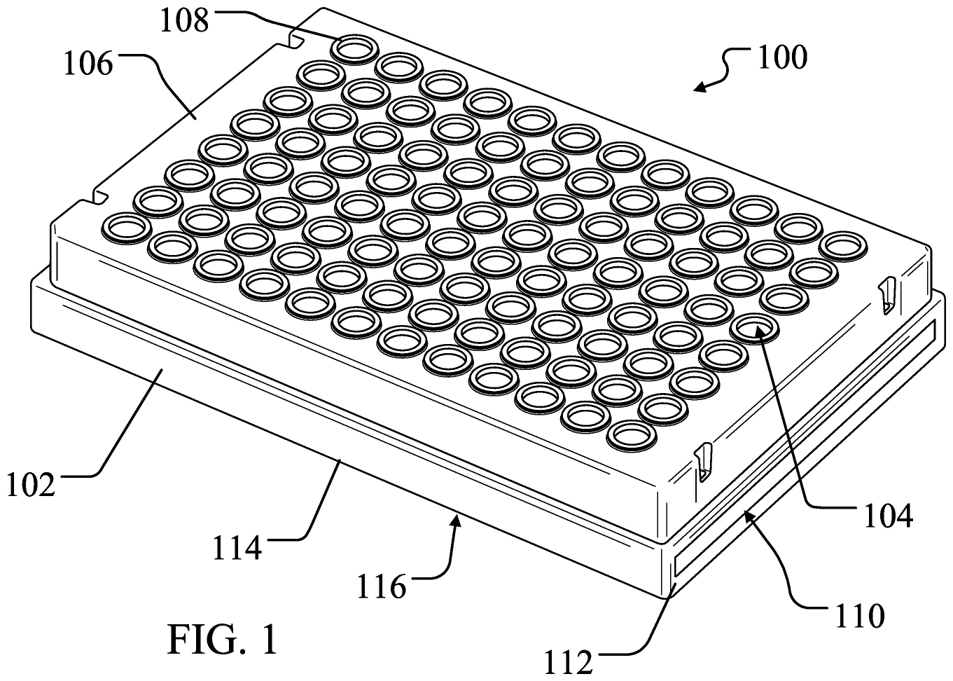

FIG. 1 is a perspective view of an example well tray 100 configured to receive a removable magnet. The well tray 100 includes a base 102 and a plurality of wells 104 arranged in a number of rows (identified as A-H) and columns (identified as 1-12). In examples, the wells 104 may be integrally formed with a body 106 that surrounds the plurality of wells 104, and the body 106 may be integrally formed with the base 102. The base 102 may also be referred to as a skirt and may have outer dimensions generally similar to, or wider than, those of the body 106. In general, the wells 104 may have an open mouth defined by an outer raised rim 108 and may be generally cylindrical or conical in shape. In other examples, the walls of the wells 104 may be straight and the base of each well 104 may be curved or concave. Different configurations and form factors of wells 104 are known in the art; particular configurations or form factors are not necessarily relevant to the present technology. As used herein, the base or skirt 102 is the portion of the well tray 100 below the base of each well 104 and is configured to receive a removeable magnet via a slot 110 formed in an edge surface 112 of the base 102. In FIG. 1, the slot 110 is disposed along the edge surface 112 parallel to the columns 1-12. In other examples of well trays, the slot may be disposed along an edge surface parallel to the rows A-H (e.g., edge surface 114). Thus, once inserted into the slot 110, the magnet is disposed above a lower surface 116 of the base 116 and below the lowermost portions (e.g., bases) of the individual wells 104.

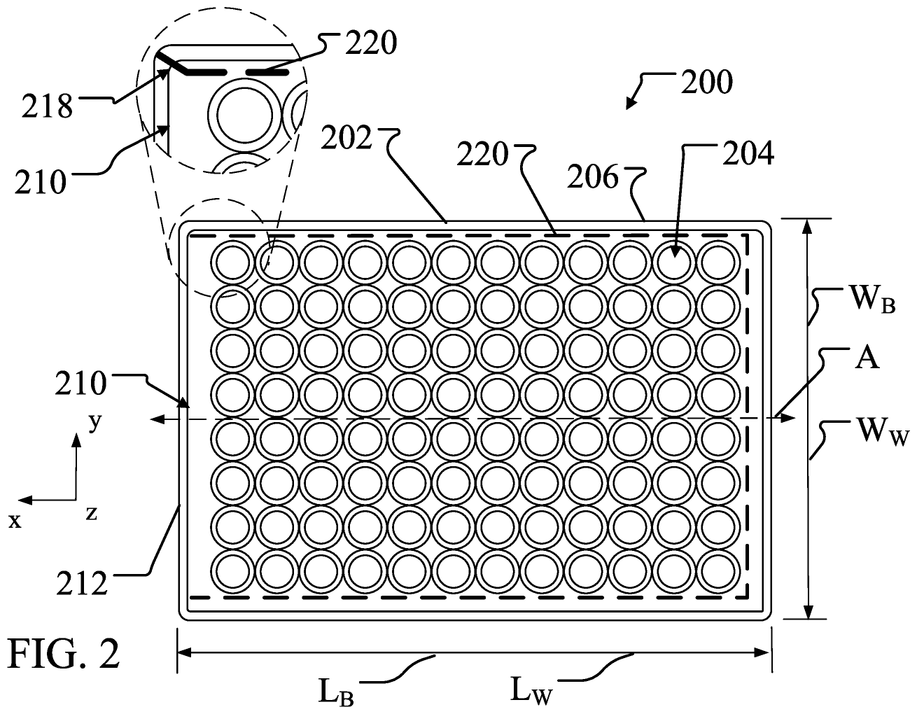

FIG. 2 depicts top and partial enlarged top views of another example of a well tray 200 configured to receive a removable magnet, along a reception axis A that corresponds to a direction of insertion and removal of a removable magnet. In this example, the dimensions of the base 202 are generally contiguous with those of the body 106. That is, the length L_{B} of the base 202 as generally the same as the length L_{W} of the body 206 defining the wells 204, and the width WB of the base 202 as generally the same as the width W_{W} of the body 206 defining the wells 204. Of course, bases having dimensions different than those of the body are also contemplated. An edge surface 212 (in this case, on the shorter side of the base 202) defines a slot 210 for receiving a removable magnet. A partially enlarged portion of the well tray 200 is also depicted and shows that the slot 214 includes a tapered throat 218 for more easily receiving the removable magnet. The throat 218 is depicted tapered inwardly along the y-axis. Alternatively or additionally, the throat 218 may be tapered along the z-axis to ease receipt of the removable magnet. Thus, one or more dimensions (e.g., width or height) of the slot 214 may be greater than those of a magnet receiver 220 (depicted with dashed lines in FIG. 2) disposed in the base 202 of the well tray 200. As can be seen, the magnet receiver 220 includes outer dimensions greater than those of the plurality of wells 204. That is, the length and width of the magnet receiver 220 is greater than each of the respective row length and column width, respectively. This helps ensure an even distribution of magnetic force below the wells 204 when a removable magnet is inserted therein. In other examples, the length and width of the magnet receiver 220 may be substantially similar to the respective length and width of the rows and columns of well 204.

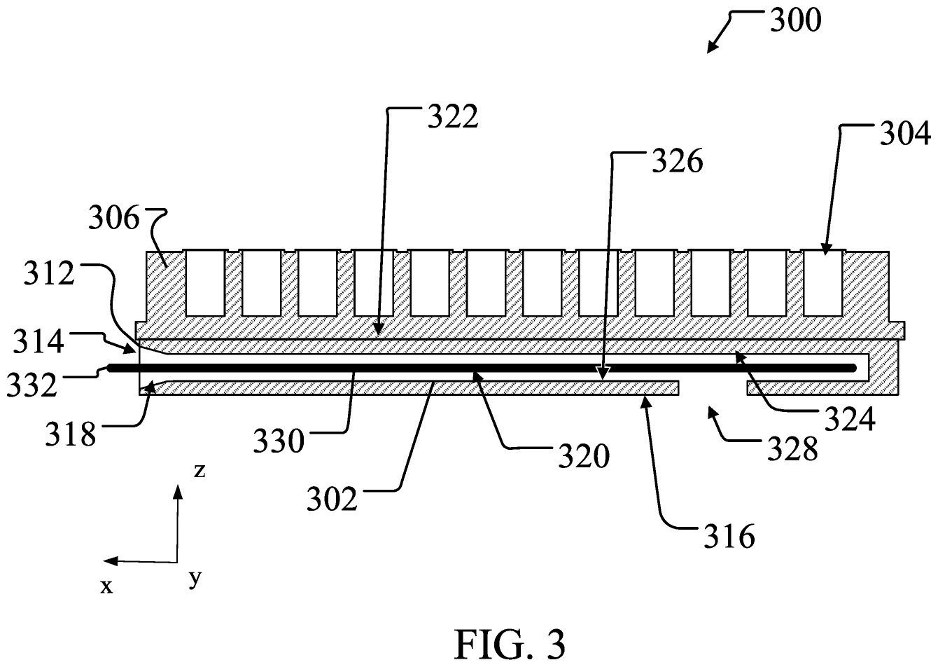

FIG. 3 is a section view of another example of a well tray 300 configured to receive a removable magnet 330. As with the examples above, the well tray 300 includes a base or skirt 302, and a body 306 disposed thereabove, which defines a plurality of wells 304. The wells 304, in this example, are substantially cylindrical. The base 302 is defined by a lower surface 316 and an upper extent 322. The upper extent 322 may be a defined structural feature such as an upper surface or wall or may be a non-physical plane defining the upper limit of the base 302. Such a non-physical plane is disposed below a bottom-most surface of each of the wells 304. Disposed between the lower surface 316 and the upper extent 322 is a magnet receiver 320 for receiving the removable magnet 330. The removable magnet 330 may be inserted into the magnet receiver 320 via a slot 314 defined by an edge surface 312. A tapered throat 318 connects the slot 314 to the magnet receiver 320. In the depicted well tray 300, the throat 318 is depicted tapered in along the z-axis. Alternatively or additionally, the throat 318 may be tapered along the y-axis.

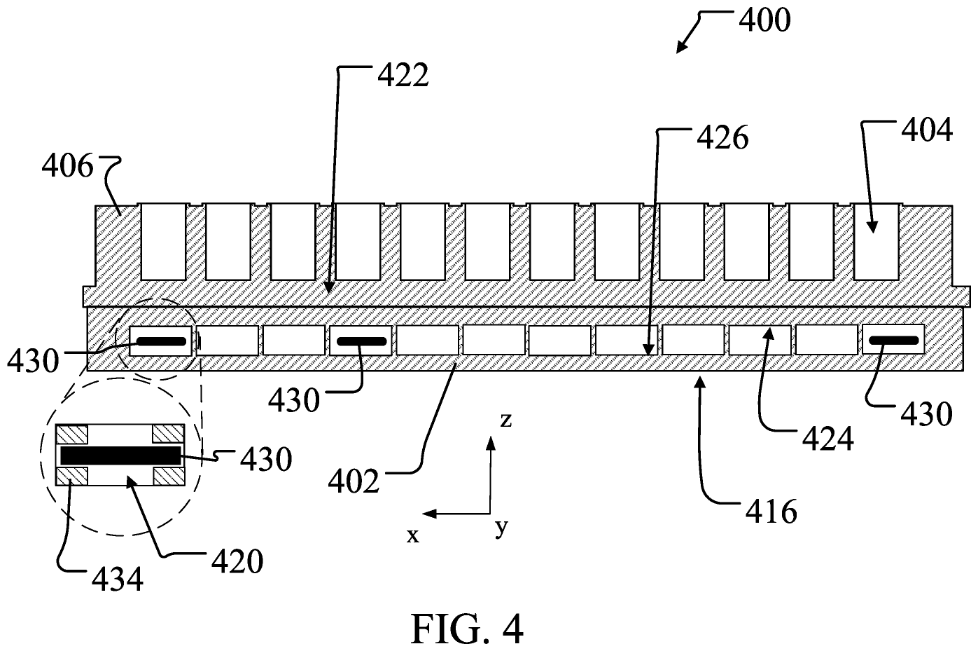

An upper surface 324 and a lower surface 326 may at least partially define surfaces against which the removable magnet slides during insertion and removal thereof. It should be noted that FIG. 3 depicts the magnet spaced apart from the upper surface 324 and lower surface 326 for clarity. In examples, however, only portions of the upper surface and lower surface proximate edges of the magnet 330 may contact the magnet 330, while portions of the surfaces 324 326 therebetween are spaced further from the magnet 330 to reduce the area of sliding surfaces and the friction associated therewith. Edge-only support of magnets is depicted below in FIG. 4. Regardless, it may be desirable that any surface within the base 302 that contacts the magnet 330 be formed from or coated with a low-friction material. Such materials include, but are not limited to, polyimides such as polytetrafluoroethylene (PTFE), polyetheretherketone (PEEK), polyphenylen sulfide (PPS), and other materials such as nylon, acetal, and polyester. Materials displaying desirable performance include those manufactured under the trade name TEFLON. Although low-friction surfaces 324, 326 may be desirable, it may also be advantageous to include one or more access openings 328 may be defined by the lower surface 316 so sliding of the magnet 330 may be more easily performed. For example, a user may use their finger to push or pull the magnet 330 during insertion of removal thereof. Such access openings 328 may be particularly desirable if the removable magnet 330 is fairly flexible or prone to bending. A number of access openings 328 may also be desirable if the magnet 330 is inserted via the longest dimension of the well tray 300, such as depicted in FIG. 3. The longer insertion distance may increase frictional forces acting against the magnet 330, thus making a number of access openings more desirable. In another example, the bottom surface 316 of the base 302 may be completely open (in other words, the bottom surface 316 itself may define an enlarged access opening 328, having dimensions just slightly smaller than the magnet receiver 320 itself), with only the edges of the magnet 330 in contact with the low-friction surfaces 324, 326 within the magnet receiver 320.

As described elsewhere herein, the magnet receiver 320 is sized to extend beyond the outermost wells 304 of the well tray 300. Thus, once inserted, the magnet 330 extends beyond the outermost wells 304 of the well tray 300 helping to ensure even application of the magnetic field on the magnetic particles disposed in the wells 304. The magnet 330 may also include a tab or extension 332 that may extend out of the slot 314 when the magnet 330 is fully received in the magnet receiver 320, allowing the tab 332 to be pinched or gripped for removal. In another example, the magnet receiver 320 may be communicatively coupled at each end to a slot so that the magnet 330 may be inserted or removed from either end of the base 302.

FIG. 4 is a section view of another example of a well tray 400 configured to receive a plurality of removable magnets 430, several of which are depicted. Each row or column of wells 404 of the well tray 400 is associated with a dedicated magnet receiver 420 disposed below the appropriate row or column. Thus, reactions using magnetic particles may be performed on the same well tray as those that do not require magnetic reactions, with magnets 430 disposed in receivers 420 below rows or columns of wells 404 that contain the magnetic particles. As with the larger magnet receivers of the previous figures, each receiver 420 includes an upper surface 424 and a lower surface 426, either or both of which may be manufactured from or coated with one or more of the low friction materials described herein. Indeed, the magnet receivers 420 are similar in function to the magnet receivers described elsewhere herein, but are instead sized to receive only a single, narrower magnet. Further, as depicted in the enlarged partial view of FIG. 4, the removable magnet 430 slides against portions of the upper surface 424 and lower surface 426 defined by enlarged rails 434. These rails 434 are located proximate the edges of the magnets 430, thus reducing frictional contact therebetween. In other examples, a single magnet receiver may be disposed below more than one row or column of wells, as required or desired for a particular application. In general, the magnet receivers 420 are disposed between an upper extent 422 of the base 402 and the lower surface 416 of the base 402 and may be access from a single or multiple slots, or from below via an access opening (not shown in FIG. 4). The insertion slot depicted in other figures are not visible in FIG. 4, indicating then that the magnet receivers 420 are oriented in a direction along the depicted y-axis (e.g., the shorter dimension of the well tray 400).

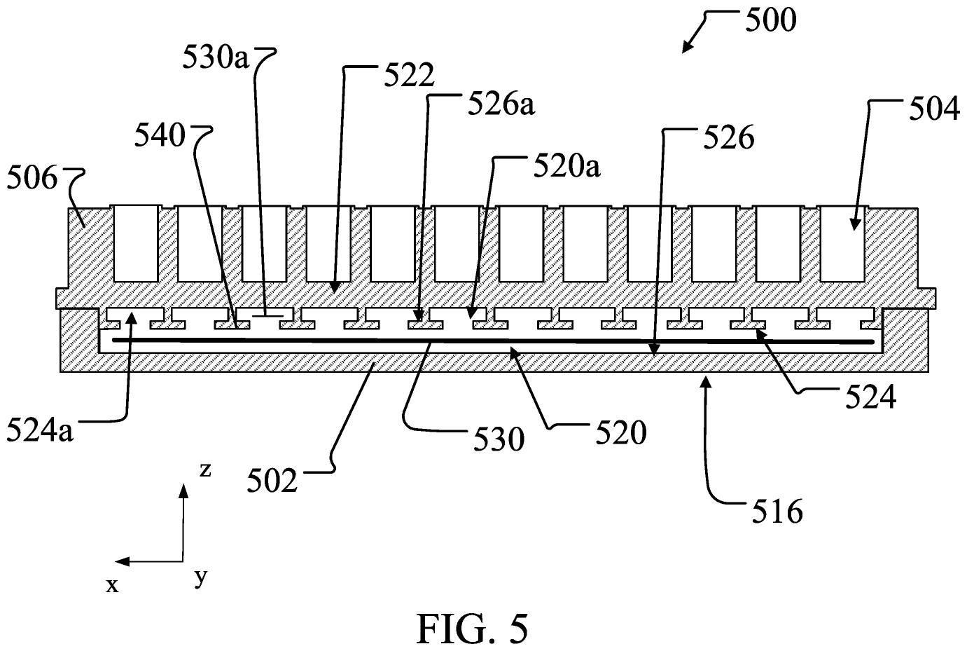

FIG. 5 is a section view of another example of a well tray 500 configured to receive a plurality of removable magnets 530, 530a, in different magnet receivers 520, 520a, respectively. A number of other features and components similar to those described above with regard to the well trays of other figures are depicted but not necessarily described further. Two types of magnet receivers 520, 520a are depicted in the well tray 500 of FIG. 5. A single magnet receiver 520 is configured to receive a single magnet 530 that is sized to apply a magnetic force to all rows and columns of wells. The single magnet receiver 520 is defined by a lower surface 526 and an upper surface 524. The upper surface 524 is formed on a bottom of a projection 540 that defines the smaller plurality of magnet receivers 520a above. As such, it may be desirable to manufacture the projections 540 from low-friction material, such as described elsewhere herein. The projections 540 may further serve the purpose of preventing upward deflection of the magnet 530. The upper plurality of magnet receivers 520a are located directly below each row or column of wells 504 and may include dimensions wider than the maximum dimensions of the wells 504, so as to distribute evenly the magnetic forces from the magnet 530a. The upper plurality of magnet receivers are defined at least partially by the projections 540 extending down from an upper surface 524a of each magnet receiver 520a. The projections 540 also define the lower surfaces 526a. Each of these surfaces 524a, 526a may also be manufactured from or coated with low friction materials. The well tray 500 is thus extremely versatile, in that magnet force may be applied to discrete rows or columns of wells 504 (with magnet(s) 530a), or to all wells 504 (with magnet 530), as required or desired for a particular application.

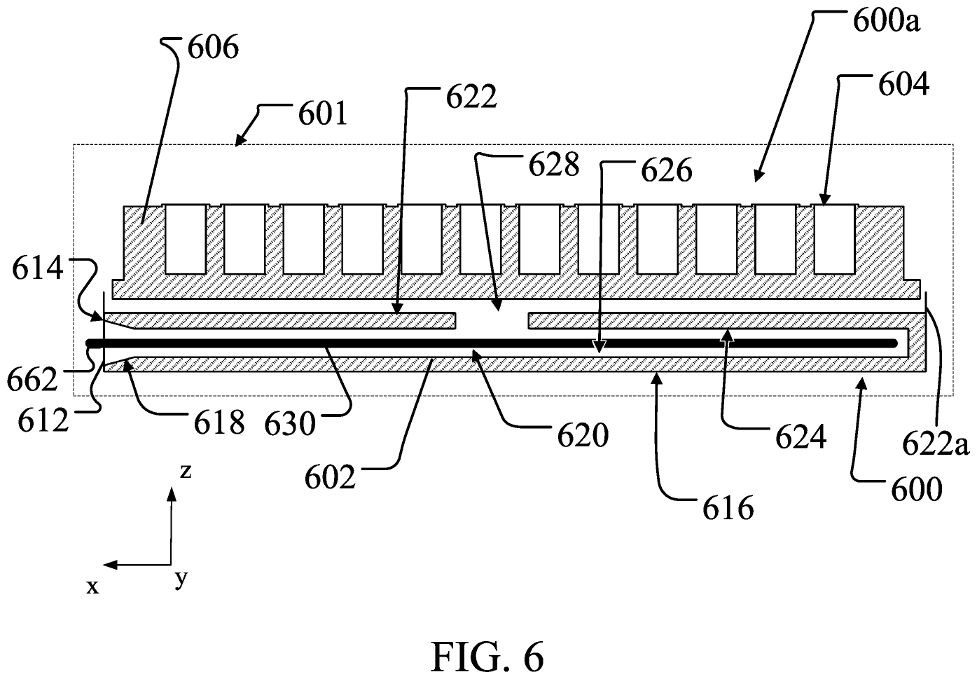

FIG. 6 is a schematic view of a platform 600 for a sample analyzer such as an imaging cytometer (depicted schematically by line 601), the platform 600 is configured to receive a removable magnet 630. A well tray 600a may be used in conjunction with the platform 600 of FIG. 6. Notably, since the magnet 630 is disposed in the platform 600, a non-skirt well tray 600a may be utilized, as additional height of a base or skirt (e.g., to accommodate a magnet) is not required. Thus, the well tray 600a includes a body 606 that defines a plurality of wells 604. The wells 604, in this example, are substantially cylindrical. The platform 600 includes a base 602 that is defined by a lower surface 616 and an upper surface 622. Further, one or more registration features 622a may be disposed on the upper surface 622. In examples, the registration features 622a may be walls that form a well tray receiver, alignment pins, a recess formed in the upper surface 622, or other features as required or desired for a particular application. Disposed between the lower surface 616 and the upper extent 622 is a magnet receiver 620 for receiving the removable magnet 630. In examples, the area defined by the registrations features 622a may be greater than the area defined by the magnet receiver 620 disposed there below. It may be desirable, however, that the magnet receiver 620 define a larger area, so as to ensure an even application of magnetic force across the entire well tray 600a and the wells 604 therein. The removable magnet 630 may be inserted into the magnet receiver 620 via a slot 614 defined by an edge surface 612 of the platform 600. A tapered throat 618 connects the slot 614 to the magnet receiver 620. In the depicted platform 600, the throat 618 is depicted tapered in along the z-axis. Alternatively or additionally, the throat 618 may be tapered along the y-axis.

An upper surface 624 and a lower surface 626 may at least partially define surfaces against which the removable magnet slides during insertion and removal thereof. As such, it may be desirable to form or coat those surfaces 624, 626 with a low-friction material, such as described elsewhere herein. Alternatively or additionally, the magnet receivers 620 may be configured to reduce contact between the surfaces 624, 626 and the removeable magnet 430, by contacting only edges thereof. Once such example of such a configuration is depicted in FIG. 4. Since the lower surface 616 of the platform 600 is generally inaccessible within the sample analyzer 601, the upper surface 622 of the platform 600 may define one or more access openings 628 so sliding of the magnet 630 may be more easily performed. Such access openings 628 may be particularly desirable if the removable magnet is fairly flexible or prone to bending. Longer insertion distances may increase frictional forces acting against the magnet 630, thus making a number of access openings 628 more desirable.

As described elsewhere herein, the magnet receiver 620 is sized to extend beyond the outermost wells 604 of the well tray 600a. Thus, once inserted, the magnet 630 extends beyond the outermost wells 604 of the well tray 600a helping to ensure even application of the magnetic field on the magnetic particles disposed in the wells 604. The magnet 630 may also include a tab or extension 632 that may extend out of the slot 614 when the magnet 630 is fully received in the magnet receiver 620, allowing the tab 632 to be pinched or gripped for removal. In another example, the magnet receiver 620 may be communicatively coupled at each end to a slot so that the magnet 630 may be inserted or removed from either end of the base 602. With regard to incorporating removable magnets into a support platform for an analyzer, other configurations that accommodate one or more removable magnets, such as depicted in FIG. 3-5 are contemplated.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

1. A well tray comprising:
a base comprising:
an upper surface;
a lower surface; and
at least one edge surface connecting the upper surface to the lower surface, wherein the at least one edge surface defines a slot, and wherein the slot is in communication with a magnet receiver at least partially defined between the upper surface and the lower surface, wherein the magnet receiver is configured to slidably receive a removable magnet; and
a plurality of wells disposed on an upper surface of the base.

2. The well tray of claim 1, wherein the plurality of wells are arranged in a plurality of columns comprising a column width dimension and a plurality of rows comprising a row length dimension, and wherein the magnet receiver comprises a receiver width dimension substantially similar to the column width dimension and a receiver length dimension substantially similar to the row length dimension.

3. The well tray of claim 1, wherein the plurality of wells are arranged in a plurality of columns comprising a column width dimension and a plurality of rows comprising a row length dimension, and wherein the magnet receiver comprises a receiver width dimension greater than the column width dimension and a receiver length dimension greater than the row length dimension.

4. The well tray of claim 2, wherein the base comprises a base width dimension greater than the column width dimension and a base length dimension greater than the row length dimension.

5. The well tray of claim 1, wherein the magnet receiver comprises a plurality of magnet receivers, wherein the plurality of magnet receivers are oriented substantially parallel with at least one of a row of the plurality of wells and at least one column of the plurality of wells.

6. The well tray of claim 1, wherein the magnet receiver defines a reception axis along which the magnet is slidably received in the magnet receiver, and wherein the magnet receiver comprises an edge support for slidably supporting an edge of the magnet.

7. The well tray of claim 6, wherein the edge support comprises a height less than a height of the magnet receiver.

8. The well tray of claim 6, wherein the edge support comprises a low-friction material.

9. The well tray of claim 6, wherein the slot comprises a magnet throat for receiving the edge of the magnet during an insertion of the magnet.

10. The well tray of claim 9, wherein the magnet throat is tapered.

11. The well tray of claim 1, wherein the lower surface at least partially defines an access opening in communication with the magnet receiver.

12. A sample analyzer comprising:
a support platform for receiving a well tray, wherein the support platform comprises:
an upper surface;
a registration feature connected to the upper surface, wherein the registration feature is configured for receiving, in a predetermined orientation, the well tray;
at least one edge surface connected to the upper surface, wherein the at least one edge surface at least partially defines a slot for slidably receiving a removable magnet; and
a magnet receiver defined by the support platform and in communication with the slot.

13. The sample analyzer of claim 12, wherein the magnet receiver is configured to slidably receive the removable magnet.

14. The sample analyzer of claim 12, wherein the registration feature is disposed so as to align the registration feature with the magnet receiver.

15. The sample analyzer of claim 12, further comprising the removable magnet, wherein the removable magnet comprises a tab, wherein the tab is configured to project from the at least one edge surface when the removable magnet is disposed in the magnet receiver.

16. The sample analyzer of claim 12, wherein the support platform at least partially defines an access opening in communication with the magnet receiver.

17. The sample analyzer of claim 12, wherein the registration feature comprises the removable magnet.

18. The sample analyzer of claim 12, wherein the registration feature comprises a plurality of projections extending from the upper surface, wherein the plurality of projections define a registration area therebetween.

19. The sample analyzer of claim 18, wherein the magnet receiver comprises a receiver area.

20. The sample analyzer of claim 19, wherein the receiver area is greater than the registration area.
